(19) United States
(12) Patent Application Publication
(10) Pub. No.: US 2024/0128812 A1
(43) Pub. Date: Apr. 18, 2024

(54) BACK-IRON COOLING FOR ELECTRIC MOTORS

(71) Applicant: GM GLOBAL TECHNOLOGY OPERATIONS LLC, Detroit, MI (US)

(72) Inventors: Farzad Samie, Franklin, MI (US); Xiaofeng Yang, Troy, MI (US); Peng Peng, Columbus, OH (US)

(21) Appl. No.: 17/968,042

(22) Filed: Oct. 18, 2022

(51) Int. Cl. H02K 1/20

(52) U.S. Cl. CPC H02K 1/20

(57) ABSTRACT

Embodiments include an electric motor and a vehicle including the same. The electric motor has a rotor and a stator having a cavity network include a first set of channels that are interleaved with a second set of channels in an axial direction, wherein each of the first set of channels and the second set of channels have a major axis oriented in a non-radial and non-tangential direction.

### INTRODUCTION

The subject disclosure relates to electric motors. In particular, the invention relates to methods and apparatus for cooling electric motors.

Electric motors can generally be described as having a stator and a rotor. The stator is fixed in place and the rotor operates relative to the stator. In electric motors, the stator is typically a current-carrying component of an electric motor, which generates a magnetic field that interacts with the rotor. The rotor of the electric motor includes a magnetic rotor and the magnetic field generated by the stator is controlled to rotate the rotor.

In general, heat is generated by the action of the electric motor in both the rotor and the stator. The stator and rotor are cooled to prevent the electric motor (i.e., the motor) from overheating. Overheating, if not properly prevented, may cause issues including but not limit to reduced magnet flux, irreversible demagnetization of magnet, insulation failure, excessive copper loss, etc., therefore causing lower power output, lower efficiency, and even motor malfunction.

Existing high-power-dense electric motors tend to be smaller in size and higher in speed. This allows an increased power density (i.e., kW/L) or specific power (i.e., kW/kg). Heat loss (i.e., heat dissipation) is a limiting factor in the design of a high-power-dense electric motor. The purpose of motor cooling is to prevent overheating therefore preventing failures and improving motor efficiency and power output especially in critical conditions (i.e., high current and high speed) as mentioned above.

### SUMMARY

In one exemplary embodiment an electric motor is provided. The electric motor has a rotor and a stator having a cavity network including a first set of channels that are interleaved with a second set of channels in an axial direction, wherein each of the first set of channels and the second set of channels have a major axis oriented in a non-radial and non-tangential direction.

In addition to one or more of the features described herein, each of the first set of channels and the second set of channels includes a first end and a second end.

In addition to one or more of the features described herein, the first end of a channel of the first set of channels is in fluid communication with the first end of adjacent channels of the second set of channels.

In addition to one or more of the features described herein, the major axis of each of the first set of channels and the second set of channels extend from the first end to the second end.

In addition to one or more of the features described herein, the major axis of each of the first set of channels is offset from a radial direction by a first acute angle in a first direction.

In addition to one or more of the features described herein, the major axis of each of the second set of channels is offset from the radial direction by the first acute angle in a direction opposite the first direction.

In addition to one or more of the features described herein, the electric motor also includes a cooling fluid manifold configured to receive a cooling fluid and distribute the cooling fluid among the first set of channels and the second set of channels.

In addition to one or more of the features described herein, the cooling fluid manifold is disposed on a first end of the cavity network.

In addition to one or more of the features described herein, the cooling fluid manifold further includes one or more fluid outlets.

In another exemplary embodiment a vehicle is provided. The vehicle includes an electric motor having a rotor and a stator having a cavity network including a first set of channels that are interleaved with a second set of channels in an axial direction, wherein each of the first set of channels and the second set of channels have a major axis oriented in a non-radial and non-tangential direction.

In addition to one or more of the features described herein, each of the first set of channels and the second set of channels includes a first end and a second end.

In addition to one or more of the features described herein, the first end of a channel of the first set of channels is in fluid communication with the first end of adjacent channels of the second set of channels.

In addition to one or more of the features described herein, the major axis of each of the first set of channels and the second set of channels extend from the first end to the second end.

In addition to one or more of the features described herein, the major axis of each of the first set of channels is offset from a radial direction by a first acute angle in a first direction.

In addition to one or more of the features described herein, the major axis of each of the second set of channels is offset from the radial direction by the first acute angle in a direction opposite the first direction.

In addition to one or more of the features described herein, the electric motor also includes a cooling fluid manifold configured to receive a cooling fluid and distribute the cooling fluid among the first set of channels and the second set of channels.

In addition to one or more of the features described herein, the cooling fluid manifold is disposed on a first end of the cavity network.

In addition to one or more of the features described herein, the cooling fluid manifold further includes one or more fluid outlets.

In another exemplary embodiment an electric motor is provided. The electric motor includes a stator having a cavity network comprising a first set of channels that are interleaved with a second set of channels in an axial direction, wherein each of the first set of channels and the second set of channels have a major axis oriented in a non-radial and non-tangential direction.

In addition to one or more of the features described herein, each of the first set of channels and the second set of channels includes a first end and a second end and wherein the first end of a channel of the first set of channels is in fluid communication with the first end of adjacent channels of the second set of channels.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a schematic diagram of an electric motor in accordance with one or more embodiments of the present disclosure;

FIGS. 3A, 3B and 3C are schematic diagrams of portions of a stator of an electric motor in accordance with one or more embodiments of the present disclosure;

FIGS. 4A and 4B are schematic diagrams of metal sheets used to form a stator of an electric motor in accordance with one or more embodiments of the present disclosure;

FIGS. 5A and 5B are schematic diagrams of a cavity network of a stator of an electric motor for use in conjunction with one or more embodiments of the present disclosure;

FIG. 6A is a schematic diagram of a cooling system of a stator of an electric motor for use in conjunction with one or more embodiments of the present disclosure;

FIG. 6B is a schematic diagram of a cooling system of a stator of an electric motor for use in conjunction with one or more embodiments of the present disclosure; and

FIG. 6C is a schematic diagram of a cooling system of a stator of an electric motor for use in conjunction with one or more embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a back-iron cooling method for a stator of an electric motor is provided. The back-iron of the stator is configured to include a cooling system that includes a cavity network and one or more cooling fluid inlets and outlets. In exemplary embodiments, cooling fluid flows into the cavity network from one or more cooling fluid inlets and out of the cavity network from one or more cooling fluid outlets. In exemplary embodiments, the cooling channels include two sets of interleaved apertures that are each disposed in a non-radial and non-tangential direction.

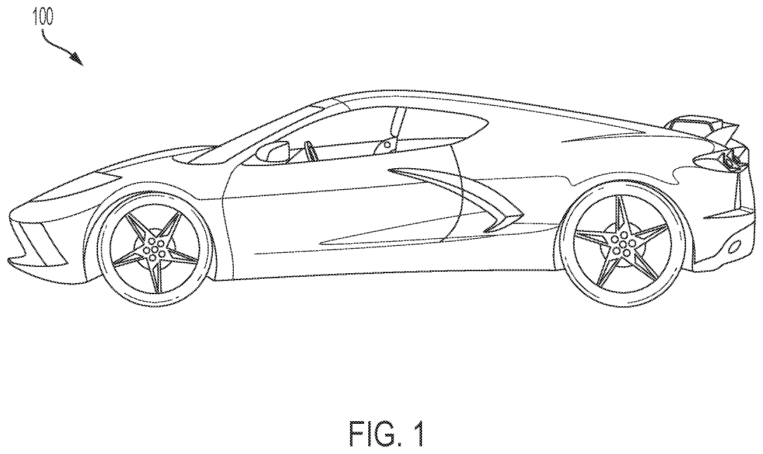

Referring now to FIG. 1, a schematic diagram of a vehicle 100 for use in conjunction with one or more embodiments of the present disclosure is shown. The vehicle 100 includes an electric motor (not shown). In one embodiment, the vehicle 100 is a hybrid vehicle that utilizes both an internal combustion engine and an electric motor. In another embodiment, the vehicle 100 is an electric vehicle that only utilizes electric motors.

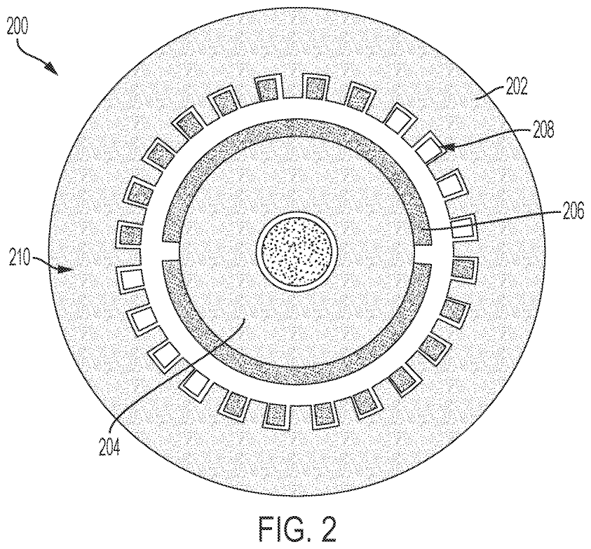

Referring now to FIG. 2, a schematic diagram of an electric motor 200 for use in conjunction with one or more embodiments of the present disclosure is shown. As illustrated, the electric motor 200 includes a stator 202 and a rotor 204. The stator 202 includes one or more windings 208 that are configured to produce an electromagnetic field and the rotor 204 includes one or more magnets 206 that are configured to interact with the electromagnetic field produced by the windings 208. The stator 202 also includes a back-iron portion 210 that is disposed around the outer circumference of the stator 202.

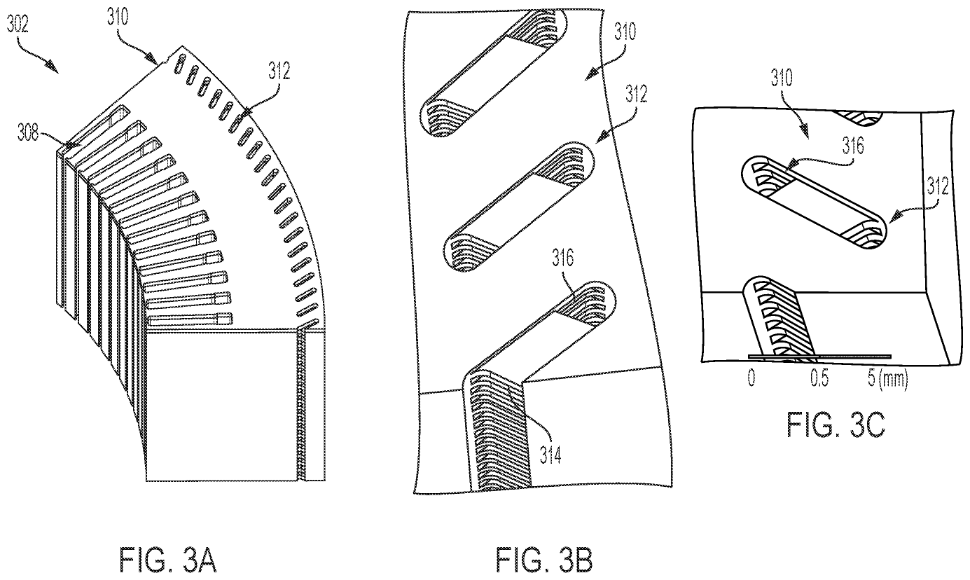

Referring now to FIGS. 3A, 3B and 3C, schematic diagrams of portions of a stator 302 of an electric motor in accordance with one or more embodiments of the present disclosure is shown. As illustrated, the stator 302 includes a plurality of channels 308 that are configured to hold windings. The stator 302 also includes a back-iron portion 310 that includes cooling channels 312. As best shown, in FIGS. 3B and 3C, the cooling channels 312 include two sets of interleaved apertures 314, 316 that are each disposed in a non-radial and non-tangential direction.

In exemplary embodiments, cooling fluid is configured to flow through the two sets of interleaved apertures 314, 316 to remove heat from the stator 302. In one embodiment, by offsetting the orientation of the interleaved apertures 314, 316 such that neither are disposed in a radial and tangential direction, the surface area of the cooling channels 312 available for heat exchange is increased.

In one embodiment, a first set of the interleaved apertures are configured to have an offset from a radial direction of approximately thirty degrees and the second set of the interleaved apertures are configured to have an offset from a radial direction of approximately thirty degrees in the opposite direction. For example, the surface area of the cooling channels 312 is approximately double the surface area of a similar set of cooling channels in which the interleaved apertures 314, 316 are configured in a tangential direction. As will be appreciated by those of ordinary skill in the art, other acute offset angles can also be used. In exemplary embodiments, the two sets of apertures 314, 316 are interleaved in an axial direction.

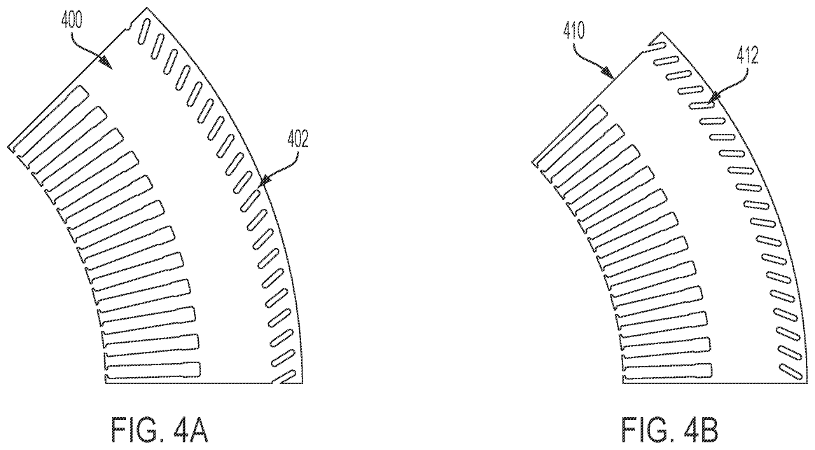

In one embodiment, the stator is formed by stacking and joining a plurality of metal sheets. FIGS. 4A and 4B illustrate metal sheets 400, 410 that are used to form a stator in accordance one or more embodiments of the present disclosure. As illustrated, the first metal sheet 400 includes a plurality of apertures 402 that are disposed around an outer portion of the sheet 400. Likewise, the second metal sheet 410 includes a plurality of apertures 412 that are disposed around an outer portion of the sheet 410. Each of the apertures 402, 412 are elongated and has a major axis that is neither radial nor tangential in orientation. In exemplary embodiments, a stator in accordance with the present disclosure, is formed by stacking a plurality of the first metal sheets 400 and the second metal sheets 410 in an interleaved manner. Once the metal sheets 400, 410 are stacked and joined, an end portion of each end of the apertures 402, 412 is configured to at least partially overlap with the end portion of the apertures of the adjacent sheets.

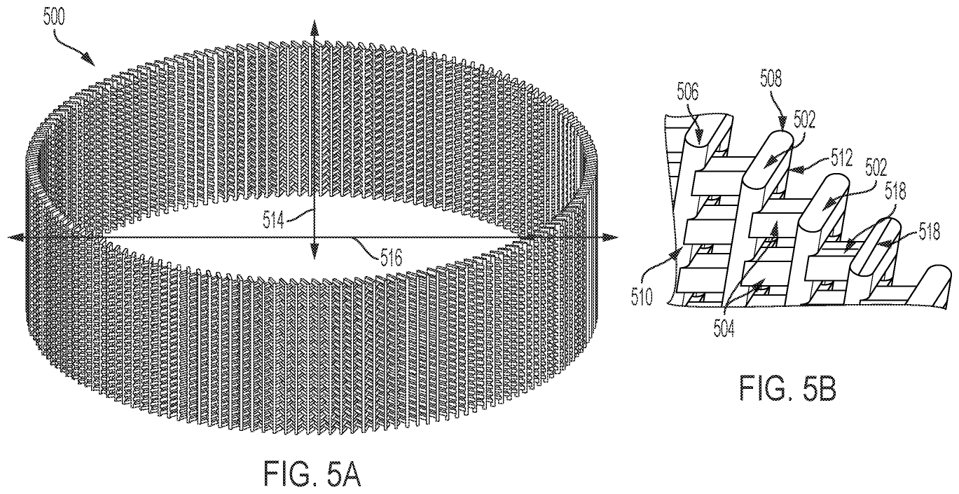

Referring now to FIGS. 5A and 5B a schematic diagram of a cavity network 500 of a stator of an electric motor for use in accordance with one or more embodiments of the present disclosure is shown. As illustrated, the cavity network 500 includes a first set of channels 502 that are interleaved with a second set of channels 504 in an axial direction 514. The first set of channels 502 includes a plurality of elongated channels that each extend from a first end 506 to a second end 508. The second set of channels 504 includes a plurality of elongated channels that each extend from a first end 510 to a second end 512.

In exemplary embodiments, a major axis 518 of each of the first set of channels 502 and the second set of channels 504 are in a non-radial and non-tangential direction. For example, in one embodiment, the major axis of each of the first set of channels 502 is offset from a radial direction 516 by approximately thirty degrees in a first direction and the major axis of each of the second set of channels 504 is offset from a radial direction by approximately thirty degrees in a direction opposite of the first direction.

In exemplary embodiments, the first end 506 of each of the first set of channels 502 is configured to overlap with the first end 510 of the second set of channels 504 that are disposed above and below the first set of channels 502. Likewise, the second end 508 of each of the first set of channels 502 is configured to overlap with the second end 512 of the second set of channels 504 that are disposed above and below the first set of channels 502. Accordingly, the first set of channels 502 and the second set of channels 504 of the cooling channels 500 are in fluid communication with one another.

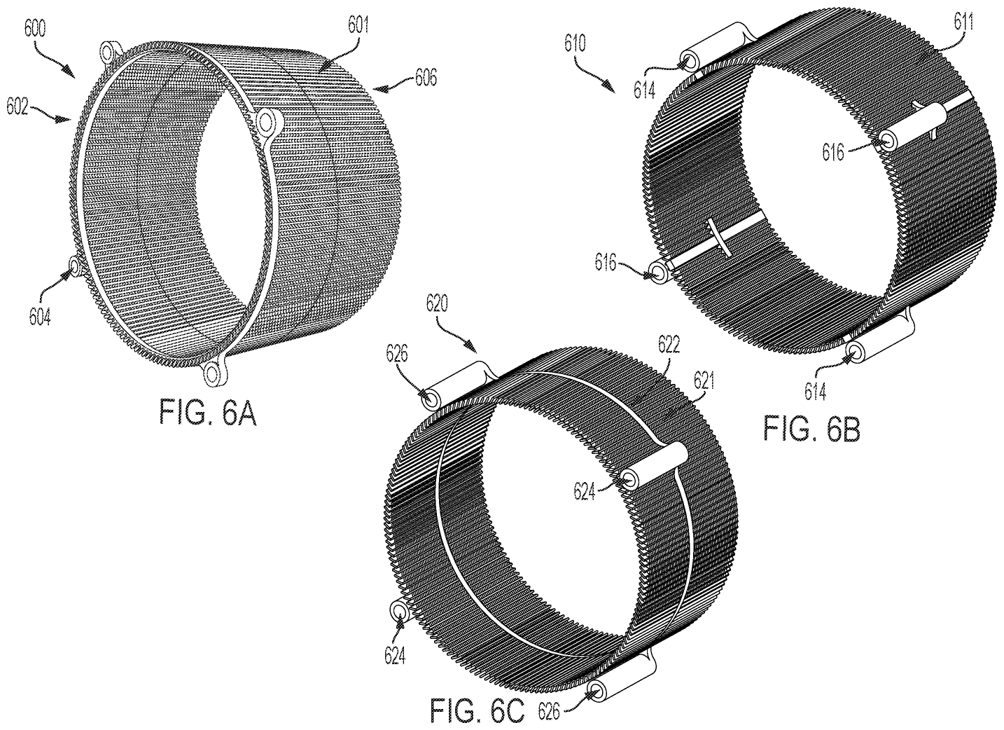

Referring now to FIG. 6A, a schematic diagram of a cooling system 600 of a stator of an electric motor for use in conjunction with one or more embodiments of the present disclosure is shown. As illustrated, the cooling system 600 includes a cavity network 601 and a manifold 602 that is in fluid communication with the cavity network 601. In exemplary embodiments, the manifold 602 is disposed on one end of the cavity network 601 and includes one or more inlets 604 that are configured to receive a cooling fluid. The manifold 602 is configured to receive and distribute a cooling fluid across the cavity network 601. After the cooling fluid passes through the cavity network 601, the cooling fluid is discharged from the cavity network 601 via outlets 606. In one embodiment, another manifold (Not shown) may be disposed at the opposite side of the cavity network 601 to collect and discharge the cooling fluid.

Referring now to FIG. 6B, a schematic diagram of a cooling system 610 of a stator of an electric motor for use in conjunction with one or more embodiments of the present disclosure is shown. As illustrated, the cooling system 610 includes a cavity network 611 and a plurality of inlets 614 and outlets 616 that are in fluid communication with the cavity network 611. In exemplary embodiments, the inlets 614 are configured to receive a cooling fluid and the outlets 616 are configured to discharge a cooling fluid after it passes through the cavity network 611.

Referring now to FIG. 6C, a schematic diagram of a cooling system 620 of a stator of an electric motor for use in conjunction with one or more embodiments of the present disclosure is shown. As illustrated, the cooling system 620 includes a cavity network 621 and a manifold 622 that is in fluid communication with the cavity network 621. In exemplary embodiments, the manifold 622 is disposed in a middle portion of the cavity network 621. The manifold 622 includes one or more inlets 624 that are configured to receive a cooling fluid and one or more outlets 626 that are configured to discharge a cooling fluid after it passes through the cavity network 621. In one embodiment, the manifold 622 includes two inlets 624 disposed on opposing sides of the cavity network 621.

In exemplary embodiments, providing a cavity network in a stator that include a first set of channels that are interleaved with a second set of channels in an axial direction, wherein each of the first set of channels and the second set of channels have a major axis oriented in a non-radial and non-tangential direction greatly increases an available surface area for heat exchange in the stator, thereby improving the performance of the electric motor.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electric motor comprising:
a rotor; and
a stator having a cavity network comprising a first set of channels that are interleaved with a second set of channels in an axial direction,
wherein each of the first set of channels and the second set of channels have a major axis oriented in a non-radial and non-tangential direction.

2. The electric motor of claim 1, wherein each of the first set of channels and the second set of channels includes a first end and a second end.

3. The electric motor of claim 2, wherein the first end of a channel of the first set of channels is in fluid communication with the first end of adjacent channels of the second set of channels.

4. The electric motor of claim 2, wherein the major axis of each of the first set of channels and the second set of channels extend from the first end to the second end.

5. The electric motor of claim 1, wherein the major axis of each of the first set of channels is offset from a radial direction by a first acute angle in a first direction.

6. The electric motor of claim 5, wherein the major axis of each of the second set of channels is offset from the radial direction by the first acute angle in a direction opposite the first direction.

7. The electric motor of claim 1, further comprising a cooling fluid manifold configured to receive a cooling fluid and distribute the cooling fluid among the first set of channels and the second set of channels.

8. The electric motor of claim 7, wherein the cooling fluid manifold is disposed on a first end of the cavity network.

9. The electric motor of claim 7, wherein the cooling fluid manifold further includes one or more fluid outlets.

10. A vehicle comprising:
an electric motor having a rotor and a stator having a cavity network comprising a first set of channels that are interleaved with a second set of channels in an axial direction,
wherein each of the first set of channels and the second set of channels have a major axis oriented in a non-radial and non-tangential direction.

11. The vehicle of claim 10, wherein each of the first set of channels and the second set of channels includes a first end and a second end.

12. The vehicle of claim 11, wherein the first end of a channel of the first set of channels is in fluid communication with the first end of adjacent channels of the second set of channels.

13. The vehicle of claim 12, wherein the major axis of each of the first set of channels and the second set of channels extend from the first end to the second end.

14. The vehicle of claim 11, wherein the major axis of each of the first set of channels is offset from a radial direction by a first acute angle in a first direction.

15. The vehicle of claim 14, wherein the major axis of each of the second set of channels is offset from the radial direction by the first acute angle in a direction opposite the first direction.

16. The vehicle of claim 11, further comprising a cooling fluid manifold configured to receive a cooling fluid and distribute the cooling fluid among the first set of channels and the second set of channels.

17. The vehicle of claim 16, wherein the cooling fluid manifold is disposed on a first end of the cavity network.

18. The vehicle of claim 16, wherein the cooling fluid manifold further includes one or more fluid outlets.

19. An electric motor comprising:
a stator having a cavity network comprising a first set of channels that are interleaved with a second set of channels in an axial direction,
wherein each of the first set of channels and the second set of channels have a major axis oriented in a non-radial and non-tangential direction.

20. The electric motor of claim 19, wherein each of the first set of channels and the second set of channels includes a first end and a second end and wherein the first end of a channel of the first set of channels is in fluid communication with the first end of adjacent channels of the second set of channels.
